(19) United States
(12) Patent Application Publication
(10) Pub. No.: US 2014/0174905 A1
(43) Pub. Date: Jun. 26, 2014

(54) PHOTO-CATALYTIC SYSTEMS FOR THE PRODUCTION OF HYDROGEN

(71) Applicant: SUNPOWER TECHNOLOGIES LLC, San Marcos, CA (US)

(72) Inventor: DANIEL LANDRY, REDONDO BEACH, CA (US)

(73) Assignee: SUNPOWER TECHNOLOGIES LLC, SAN MARCOS, CA (US)

(21) Appl. No.: 13/722,355

(22) Filed: Dec. 20, 2012

(51) Int. Cl. B01J 27/057; C01B 3/04

(52) U.S. Cl. CPC B01J 27/0576; B01J 27/0573; C01B 3/042; Y10S 977/892; Y10S 977/774; Y10S 977/784; B82Y 40/00
USPC 204/157.5; 502/100; 502/305; 502/338; 502/200; 502/353; 502/343; 502/350; 502/174; 502/215; 977/892; 977/774; 977/784

(57) ABSTRACT

A system and method for splitting water to produce hydrogen and oxygen employing sunlight energy are disclosed. Hydrogen and oxygen may then be stored for later use as fuels. The system and method use inorganic capping agents that cap the surface of semiconductor nanocrystals to form photocatalytic capped colloidal nanocrystals, which may be deposited on a substrate and treated to form a photoactive material. The photoactive material may be employed in the system to harvest sunlight and produce energy necessary for water splitting. The system may also include elements necessary to collect, transfer and store hydrogen and oxygen, for subsequent transformation into electrical energy.

### BACKGROUND

1. Field of the Disclosure

The present disclosure relates to hydrogen generation systems, and more particularly hydrogen generation systems in which solar energy is used for the photocatalytic decomposition of water.

2. Background

At current rates of energy usage, it is expected that the world will face a roughly 14 TW energy gap by 2050, increasing to around 33 TW by 2100. Renewable energy resources such as wind, tidal, geothermal, nuclear, biomass, and hydroelectric are unlikely to provide sufficient amounts of energy. In contrast, the sun produces 10×10¹⁵ TW of clean energy that reaches the surface of the earth, of which around 600 TW can be utilized.

Enormous efforts have been recently attracted to seek new materials and/or novel structures for efficient solar energy conversions owing to the increasing awareness of devastating environmental impact of fossil fuel usages in meeting energy needs. To be economically competitive, solar energy needs to be converted into other forms that can be directly utilized with high efficiency and low cost.

Because a chemical energy carrier offers the only practical means for storing large amounts of energy, hydrogen is a primary candidates for future energy storage. Although many methods exist for the production of hydrogen, most of those methods have problems regarding production efficiency and costs. For instance, hydrogen production through thermo-decomposition requires high temperatures of about 3000-4000° C. Another method, electrolysis, requires high voltage, consuming significant amount of energy.

Photoelectric materials are candidates for an efficient method for producing hydrogen. These materials exhibit strong UV/visible light absorption; high chemical stability in the dark and under illumination; suitable band edge alignment to enable reduction/oxidation of water; efficient charge transport in the semiconductor; and low over potentials for the reduction/oxidation reactions.

One attractive technology for producing hydrogen employs photo-electrochemical devices (PEC cells) for water splitting—cleaving water molecules into their components, hydrogen and oxygen. The overall efficiency of such PEC cells would be determined by the basic working principles and properties of photoactive materials. The tremendous progress made in the field of nanostructured materials may provide new opportunities for efficiently harnessing this technique.

Water Splitting with Nano-Sized Photocatalysts

As distinct from bulk photocatalysts, realized as thin films on conducting substrates, water splitting with nano-sized photocatalysts simply utilizes a photocatalyst material immersed in water. The principles of photocatalytic water splitting offer a favorable match. This method requires high surface areas for electron excitation and collection, coupled with the use of nanocatalysts, which offer high surface to volume ratios. Semiconductor nanocrystals can improve photocatalysis through the combined effects of quantum confinement and unique surface morphologies. Quantum confinement allows the use of materials that are not suitable semiconductors in bulk form due to insufficient energetic electrons or holes on a nano scale. Surface modification of nano-sized catalysts may affect redox potentials and may be used to enhance the efficiency of charge transfer and charge separation. Furthermore, the problem of poor carrier transport in some bulk materials can be significantly alleviated on a nano scale, as the distance that photo generated carriers have to travel to reach the surface is significantly decreased.

Nanometer-scaled composites provide the opportunity to combine useful attributes of two or more materials within a single composite. Alternatively, one may generate entirely new properties as a result of the intermixing of two or more materials. Semiconductor nano crystals also provide an improved degree of electronic and structural flexibility, primarily exemplified by the ability to continuously tailor the size of the particles and therefore, via quantum confinement effects, the electronic properties of the particles. An appropriately-tailored inorganic nanocomposite may provide outstanding thermoelectric characteristics. Inorganic nanocomposites may also exhibit high tunability.

Useful properties can be expected as a result of the nanometer scale integration of inorganic components. Several useful examples of inorganic nanocomposites include an intimate network of n- and p-type semiconductors. The n- and p-type semiconductors should have appropriate choice of band gaps and offsets. The resulting array of distributed p-n junctions would be useful for solar cell technology.

There still exists a need for improvement in this field, including the need for development of improved materials and devices that may operate with higher energy conversion efficiency.

### SUMMARY

According to various embodiments, a system and method are provided for splitting water to produce hydrogen and oxygen employing sunlight energy. The hydrogen and oxygen produced may be stored to be thereafter used as a fuel to power one or more applications. The system includes semiconductor nanocrystals capped with inorganic capping agents, creating a photocatalytic capped colloidal nanocrystal composition that may be deposited on a substrate and treated to form a solid matrix of photoactive material.

In one aspect of the present disclosure, a method for producing photocatalytic capped colloidal nanocrystals may synthesize semiconductor nanocrystals and substitute organic capping agents with inorganic capping agents. To synthesize semiconductor nanocrystals, a semiconductor nanocrystal precursor and an organic solvent may react producing organic capped semiconductor nanocrystals. In order to substitute organic capping agents with inorganic capping agents, the inorganic capping agent may be dissolved in a polar solvent (first solvent), while the organic capped semiconductor nanocrystals may be dissolved in an immiscible, generally non-polar solvent (second solvent). These two solutions are then combined in a single vessel. The semiconductor nanocrystal reacts with the inorganic capping agent at or near the solvent boundary and a portion of the organic capping agent is displaced by the inorganic capping agent. The process continues until equilibrium is established between the inorganic capping agent on a semiconductor nanocrystal and the free inorganic capping agent. The semiconductor nanocrystals obtained after the capping agents exchange may be stable for a few days, after which photocatalytic capped colloidal nanocrystals may precipitate out from the solution.

In another embodiment, deposition on a substrate may not be needed. Accordingly, the photocatalytic capped colloidal nanocrystals composition may be deposited into a crucible to be then annealed and subsequently ground into particles and sintered together to form the photoactive material that may be deposited on a surface where the photoactive material may adhere. In another embodiment, ground particles of photocatalytic capped colloidal nanocrystals may be used directly as a photoactive material.

A further aspect of the present disclosure is a process for splitting water molecules, employing the photocatalytic capped colloidal nanocrystals set out above. The photoactive material produced may be submerged in water contained in a reaction vessel so that a water splitting process may take place. When the semiconductor nanocrystals in the photoactive material are illuminated with photons of energy larger than the materials band gap, electrons may be excited from the valence band into the conduction band. The excited electrons may reduce water molecules and form hydrogen gas. The holes that remain in the valence band may migrate to the surface, where holes may oxidize water, forming oxygen gas. The energy gap of the absorber semiconductor nanocrystals should be large enough to drive the water splitting reaction but small enough to absorb a large fraction of sunlight energy incident upon the surface of the earth.

Semiconductor nanocrystals in the photoactive material may absorb light at different tunable wavelengths as a function of the particle size and generally at shorter wavelengths from the bulk material. Materials of the semiconductor nanocrystals may be selected in accordance with the irradiation wavelength. Changing the materials and shapes of semiconductor nanocrystals may enable tuning of the band-gap and band-offsets to expand the range of wavelengths usable by the photoactive material. According to various embodiments, photocatalytic capped colloidal nanocrystals may exhibit a plurality of configurations, including sphere, tetrapod, and core/shell, among others. The structure of the inorganic capping agents may speed up the reaction by quickly transferring charge carriers sent by semiconductor nanocrystals to water, so that the redox reaction and consequent water splitting take place at a faster and more efficient rate and at the same time inhibiting electron-hole recombination. Consequently, the redox reaction and water splitting process may occur at a faster and more efficient rate. As a result of employing the photoactive material of the present disclosure, greater sunlight energy extraction may be achieved, since tuning band gaps may expand the range of wavelengths usable by the photoactive material. In addition, semiconductor nanocrystals may provide for higher surface area available for the absorption of light.

A water splitting system employing the water splitting process may include elements for providing water into the reaction vessel (e.g., a device including a pump, a regulator, a blower, or any combination thereof) and elements for collecting (e.g., a device including a separator, a membrane, a filter, or any combination thereof) the hydrogen and oxygen gases produced.

Additionally, an energy generation system including the water splitting system, may include storage of hydrogen and oxygen gases in different containers, to be later used as a carbon neutral fuel source. In some cases, the hydrogen and oxygen gases produced may be converted to water using a secondary device, for example, an energy conversion device such as a fuel cell. An energy conversion device, in some embodiments, may be used to provide at least a portion of the energy required to operate an automobile, a house, a village, a cooling device (e.g., a refrigerator), or any other electrically driven applications.

### BRIEF DESCRIPTION OF THE DRAWINGS

Embodiments of the present invention are described by way of example with reference to the accompanying figures, which are schematic and are not intended to be drawn to scale. Unless indicated as representing the prior art, the figures represent aspects of the invention.

FIG. 1 is a flow diagram of a method for forming a composition of photocatalytic capped colloidal nanocrystals.

FIG. 2 depicts an illustrative embodiment of a sphere configuration of photocatalytic capped colloidal nanocrystals.

FIG. 3 depicts an illustrative embodiment of a tetrapod configuration of photocatalytic capped colloidal nanocrystals.

FIG. 4 depicts an illustrative embodiment of a core/shell configuration of photocatalytic capped colloidal nanocrystals.

FIG. 5 shows another embodiment of a graphene configuration of photocatalytic capped colloidal nanocrystals including graphene oxide (GO).

FIG. 6 depicts an embodiment of a spraying deposition and annealing method used to apply and treat photocatalytic capped colloidal nanocrystals on a substrate.

FIG. 7 illustrates a photoactive material employed in the present disclosure.

FIG. 8 shows the water splitting process taking place in a reaction vessel.

FIG. 9 depicts the charge separation process that may occur during water splitting process.

FIG. 10 shows an embodiment of water splitting process, where photoactive material may include photocatalytic capped colloidal nanocrystals in tetrapod configuration.

FIG. 11 shows a water splitting system employing a disclosed water splitting process.

FIG. 12 depicts an energy generation system that may be used to produce and store hydrogen and oxygen gases for generating electricity.

FIG. 13 shows a hydrogen fuel cell that may be used for mixing hydrogen and oxygen gases for the production of electricity and water.

### DETAILED DESCRIPTION

### Definitions

As used here, the following terms have the following definitions:

“Semiconductor nanocrystals” refers to particles sized between about 1 and about 100 nanometers made of semiconducting materials.

“Electron-hole pairs” refers to charge carriers that are created when an electron acquires energy sufficient to move from a valence band to a conduction band and creates a free hole in the valence band, thus initiating a process of charge separation.

“Inorganic capping agent” refers to semiconductor particles that cap semiconductor nanocrystals.

“Photoactive material” refers to a substance capable of a chemical or physical change in response to light.

“Nanocrystal growth” refers to a synthetic process including the reacting of component precursors of a semiconductor crystal in the presence of a stabilizing organic ligand, taking into account process parameters in order to control the growth and physical or chemical properties of the nanocrystals.

### Method for Forming Composition of Photocatalytic Capped Colloidal Nanocrystals

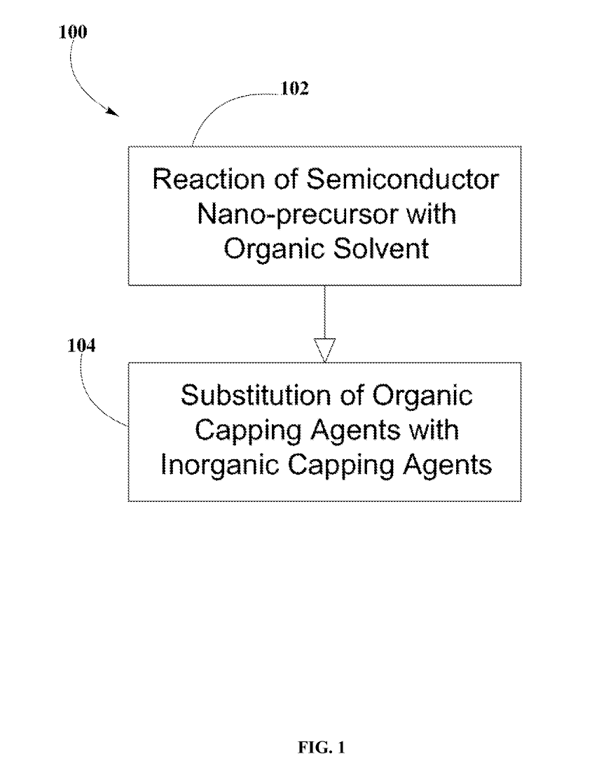

FIG. 1 is a flow diagram of a method 100 for forming a composition of photocatalytic capped colloidal nanocrystals. Photocatalytic capped colloidal nanocrystals may be synthesized following conventional protocols known to those of skill in the art. Photocatalytic capped colloidal nanocrystals may include one or more semiconductor nanocrystals and one or more inorganic capping agents.

To synthesize the photocatalytic capped colloidal nanocrystals, semiconductor nanocrystals are first grown by reacting semiconductor nanocrystal precursors in the presence of an organic solvent 102. Here, the organic solvent may be a stabilizing organic ligand, referred in this description as an organic capping agent. One example of an organic capping agent may be trioctylphosphine oxide (TOPO). This compound may be used in the manufacture of CdSe, among other semiconductor nanocrystals. TOPO 99% may be obtained from Sigma-Aldrich (St. Louis, Mo.). TOPO capping agent prevents the agglomeration of semiconductor nanocrystals during and after their synthesis. Additionally, the long organic chains radiating from organic capping agents on the surface of semiconductor nanocrystals may assist in suspending or dissolving those nanocrystals in a solvent. Other suitable organic capping agents may include long-chain aliphatic amines, long-chain aliphatic phosphines, long-chain aliphatic carboxylic acids, long-chain aliphatic phosphonic acids and mixtures thereof.

Examples of semiconductor nanocrystals may include the following: AlN, AlP, AlAs, Ag, Au, Bi, Bi₂S₃, Bi₂Se₃, Bi₂Te₃, CdS, CdSe, CdTe, Co, CoPt, CoPt₃, Cu, Cu₂S, Cu₂Se, CuInSe₂, CuIn₍₁₋ₓ₎Gaₓ(S,Se)₂, Cu₂ZnSn(S,Se)₄, Fe, FeO, Fe₂O₃, Fe₃O₄, FePt, GaN, GaP, GaAs, GaSb, GaSe, Ge, HgS, HgSe, HgTe, InN, InP, InSb, InAs, Ni, PbS, PbSe, PbTe, Pd, Pt, Ru, Rh, Si, Sn, ZnS, ZnSe, ZnTe, and mixtures of those compounds. Additionally, examples of applicable semiconductor nanocrystals may further include core/shell semiconductor nanocrystals such as Au/PbS, Au/PbSe, Au/PbTe, Ag/PbS, Ag/PbSe, Ag/PbTe, Pt/PbS, Pt/PbSe, Pt/PbTe, Au/CdS, Au/CdSe, Au/CdTe, Ag/CdS, Ag/CdSe, Ag/CdTe, Pt/CdS, Pt/CdSe, Pt/CdTe, Au/FeO, Au/Fe₂O₃, Au/Fe₃O₄, Pt/FeO, Pt/Fe₂O₃, Pt/Fe₃O₄, FePt/PbS, FePt/PbSe, FePt/PbTe, FePt/CdS, FePt/CdSe, FePt/CdTe, CdSe/CdS, CdSe/ZnS, InP/CdSe, InP/ZnS, InP/ZnSe, InAs/CdSe, and InAs/ZnSe; nanorods such as CdSe; core/shell nanorods such as CdSe/CdS; nano-tetrapods such as CdTe, and core/shell nano-tetrapods such as CdSe/CdS.

The chemistry of capping agents may control several system parameters. For example, varying the size of semiconductor nanocrystals may often be achieved by changing the reaction time, reaction temperature profile, or structure of the organic capping agent used to passivate the surface of semiconductor nanocrystals during growth. Other factors may include growth rate or shape, the dispersability in various solvents and solids, and even the excited state lifetimes of charge carriers in semiconductor nanocrystals. The flexibility of synthesis is demonstrated by the fact that often one capping agent may be chosen for its growth control properties, and then later a different capping agent may be substituted to provide a more suitable interface or to modify optical properties or charge carrier mobility. As known in the art, a number of synthetic routes for growing semiconductor nanocrystals may be employed, such as a colloidal route, as well as high-temperature and high-pressure autoclave-based methods. In addition, traditional routes using high temperature solid state reactions and template-assisted synthetic methods may be used.

The morphologies of semiconductor nanocrystals may include nanocrystals, nanorods, nanoplates, nanowires, dumbbell-like nanoparticles, and dendritic nanomaterials. Each morphology may include an additional variety of shapes such as spheres, cubes, tetrahedra (tetrapods), among others. Neither the morphology nor the size of semiconductor nanocrystals inhibits method 100; rather, the selection of morphology and size of semiconductor nanocrystals may permit the tuning and control of the properties of photocatalytic capped colloidal nanocrystals.

In alternative embodiments seeking to modify optical properties as well as to enhance charge carriers mobility, semiconductor nanocrystals may be capped by inorganic capping agents in polar solvents instead of organic capping agents. In those embodiments, inorganic capping agents may act as photocatalysts to facilitate a photocatalytic reaction on the surface of semiconductor nanocrystals. Optionally, semiconductor nanocrystals may be modified by the addition of not one but two different inorganic capping agents. In that instance, a reduction inorganic capping agent is first employed to facilitate the reduction half-cell reaction; then, an oxidation inorganic capping agent facilitates the oxidation half-cell reaction.

Inorganic capping agents may take many forms. In some embodiments these agents may be neutral or ionic, or they may be discrete species, either linear or branched chains, or two-dimensional sheets. Ionic inorganic capping agents are commonly referred to as salts, pairing a cation and an anion. The portion of the salt specifically referred to as an inorganic capping agent is the ion that displaces the organic capping agent.

Additionally, method 100 involves substitution of organic capping agents with inorganic capping agents 104. There, organic capped semiconductor nanocrystals in the form of a powder, suspension, or a colloidal solution, may be mixed with inorganic capping agents, causing a reaction of organic capped semiconductor nanocrystals with inorganic capping agents. This reaction rapidly produces insoluble and intractable materials. Then, a mixture of immiscible solvents may be used to control the reaction, facilitating a rapid and complete exchange of organic capping agents with inorganic capping agents. During this exchange, organic capping agents are released.

Generally, inorganic capping agents may be dissolved in a polar solvent, while organic capped semiconductor nanocrystals may be dissolved in an immiscible, generally non-polar, solvent. These two solutions may then be combined and stirred for about 10 minutes, after which a complete transfer of semiconductor nanocrystals from the non-polar solvent to the polar solvent may be observed. Immiscible solvents may facilitate a rapid and complete exchange of organic capping agents with inorganic capping agents.

Organic capped semiconductor nanocrystals may react with inorganic capping agents at or near the solvent boundary, where a portion of the organic capping agent may be exchanged/replaced with a portion of the inorganic capping agent. Thus, inorganic capping agents may displace organic capping agents from the surface of semiconductor nanocrystals, and inorganic capping agents may bind to that. This process continues until equilibrium is established between inorganic capping agents and the free inorganic capping agents. Preferably, the equilibrium favors inorganic capping agents. All the steps described above may be carried out in a nitrogen environment inside a glove box.

Examples of polar solvents may include 1,3-butanediol, acetonitrile, ammonia, benzonitrile, butanol, dimethylacetamide, dimethylamine, dimethylethylenediamine, dimethylformamide, dimethylsulfoxide (DMSO), dioxane, ethanol, ethanolamine, ethylenediamine, ethyleneglycol, formamide (FA), glycerol, methanol, methoxyethanol, methylamine, methylformamide, methylpyrrolidinone, pyridine, tetramethylethylenediamine, triethylamine, trimethylamine, trimethylethylenediamine, water, and mixtures thereof.

Examples of non-polar or organic solvents may include pentane, pentanes, cyclopentane, hexane, hexanes, cyclohexane, heptane, octane, isooctane, nonane, decane, dodecane, hexadecane, benzene, 2,2,4-trimethylpentane, toluene, petroleum ether, ethyl acetate, diisopropyl ether, diethyl ether, carbon tetrachloride, carbon disulfide, and mixtures thereof; provided that organic solvent is immiscible with polar solvent. Other immiscible solvent systems that are applicable may include aqueous-fluorous, organic-fluorous, and those using ionic liquids.

Polar solvents such as spectroscopy grade FA, and DMSO, anhydrous, 99.9% may be supplied by Sigma-Aldrich. Suitable colloidal stability of semiconductor nanocrystals dispersions is mainly determined by the solvent dielectric constant, which may range between about 106 to about 47, with 106 being preferred.

The purification of inorganic capped semiconductor nanocrystals may require an isolation procedure, such as the precipitation of inorganic product. That precipitation permits one of ordinary skill to wash impurities and/or unreacted materials out of the precipitate. Such isolation may allow for the selective application of photocatalytic capped colloidal nanocrystals.

Preferred inorganic capping agents for photocatalytic capped colloidal nanocrystals may include polyoxometalates and oxometalates, such as tungsten oxide, iron oxide, gallium zinc nitride oxide, bismuth vanadium oxide, zinc oxide, titanium dioxide, among others.

Inorganic capping agents may include metals selected from transition metals. Additionally, inorganic capping agent may be Zintl ions. As used here, Zintl ions may refer to homopolyatomic anions and heteropolyatomic anions that may have intermetallic bonds between the same or different metals of the main group, transition metals, lanthanides, and/or actinides. Examples of Zintl ions may include: As₃³⁻, As₄²⁻, As₅³⁻, As₇³⁻, Ae₁₁³⁻, AsS₃³⁻, As₂Se₆³⁻, As₂Te₆³⁻, As₁₀Te₃²⁻, Au₂Te₄²⁻, Au₃Te₄³⁻, Bi₃³⁻, Bi₄²⁻, Bi₅³⁻, GaTe²⁻, Ge₉²⁻, Ge₉⁴⁻, Ge₂S₆⁴⁻, HgSe₂²⁻, Hg₃Se₄²⁻, In₂Se₄²⁻, In₂Te₄²⁻, Ni₅Sb₁₇⁴⁻, Pb₅²⁻, Pb₇⁴⁻, Pb₉⁴⁻, Pb₂Sb₂²⁻, Sb₃³⁻, Sb₄²⁻, Sb₇³⁻, SbSe₄³⁻, SbSe₄⁵⁻, SbTe₄⁵⁻, Sb₂Se₃⁻, Sb₂Te₅⁴⁻, Sb₂Te₇⁴⁻, Sb₄Te₄⁴⁻, Sb₉Te₆³⁻, Se₂²⁻, Se₃²⁻, Se₄²⁻, Se_{5,6}²⁻, Se₆²⁻, Sn₅²⁻, Sn₉³⁻, Sn₉⁴⁻, SnS₄⁴⁻, SnSe₄⁴⁻, SnTe₄⁴⁻, SnS₄Mn₂⁵⁻, SnS₂S₆⁴⁻, Sn₂Se₆⁴⁻, Sn₂Te₆⁴⁻, Sn₂Bi₂²⁻, Sn₈Sb³⁻, Te₂²⁻, Te₃²⁻, Te₄²⁻, Tl₂Te₂²⁻, TlSn₈³⁻, TlSn₈⁵⁻, TlSn₉³⁻, TlTe₂²⁻, mixed metal SnS₄Mn₂⁵⁻, among others. The positively charged counter ions may be alkali metal ions, ammonium, hydrazinium, tetraalkylammonium, among others.

Further embodiments may include other inorganic capping agents. For example, inorganic capping agents may include molecular compounds derived from CuInSe₂, CuInₓGa₁₋ₓSe₂, Ga₂Se₃, In₂Se₃, In₂Te₃, Sb₂S₃, Sb₂Se₃, Sb₂Te₃, and ZnTe.

Still further, inorganic capping agents may include mixtures of Zintl ions and molecular compounds.

These inorganic capping agents further may include transition metal chalcogenides, examples of which may include the tetrasulfides and tetraselenides of vanadium, niobium, tantalum, molybdenum, tungsten, and rhenium, and the tetratellurides of niobium, tantalum, and tungsten. These transition metal chalcogenides may further include the monometallic and polymetallic polysulfides, polyselenides, and mixtures thereof, such as MoS(Se₄)₂²⁻, Mo₂S₆²⁻, among others.

Method 100 may be adapted to produce a wide variety of photocatalytic capped colloidal nanocrystals. Adaptations of this method 100 may include adding two different inorganic capping agents to a single semiconductor nanocrystals (e.g., Au.(Sn₂S₆;In₂Se₄); Cu₂Se.(In₂Se₄;Ga₂Se₃)), adding two different semiconductor nanocrystals to a single inorganic capping agent (e.g., (Au;CdSe).Sn₂S₆; (Cu₂Se;ZnS).Sn₂S₆), adding two different semiconductor nanocrystals to two different inorganic capping agents (e.g., (Au;CdSe).(Sn₂S₆;In₂Se₄)), and/or additional multiplicities.

The sequential addition of inorganic capping agents to semiconductor nanocrystals may be possible under the disclosed method 100. Depending, for example, upon concentration, nucleophilicity, bond strength between capping agents and semiconductor nanocrystal, and bond strength between semiconductor nanocrystal face dependent capping agent and semiconductor nanocrystal, inorganic capping of semiconductor nanocrystals may be manipulated to yield other combinations.

Suitable photocatalytic capped colloidal nanocrystals may include Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄, FePt/PbSe.SnS₄, FePt/PbTe.SnS₄, FePt/CdS.SnS₄, FePt/CdSe.SnS₄, FePt/CdTe.SnS₄, Au/PbS.In₂Se₄, Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄ FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄, CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄.

As used here, the denotation Au.Sn₂S₆ may refer to an Au semiconductor nanocrystal capped with a Sn₂S₆ inorganic capping agent. Charges on the inorganic capping agent are omitted for clarity. This notation [semiconductor nanocrystal].[inorganic capping agent] is used throughout this description. The specific percentages of semiconductor nanocrystals and inorganic capping agents may vary between different types of photocatalytic capped colloidal nanocrystal.

One embodiment of the method 100 to substitute an organic capping agent on semiconductor nanocrystals with an inorganic capping agent may be illustrated when CdSe is capped with a layer of organic capping agent and is soluble in non-polar or organic solvents such as hexane. Inorganic capping agent, Sn₂Se₆²⁻, is soluble in polar solvents such as DMSO. DMSO and hexane are appreciably immiscible, however. Therefore, a hexane solution of CdSe floats on a DMSO solution of Sn₂Se₆²⁻. Within a short time after combining the two solutions (about 10 minutes), the color of the hexane solution fades due to the CdSe. At the same time, the DMSO layer becomes colored as the organic capping agents are displaced by the inorganic capping agents. The resulting surface-charged semiconductor nanocrystals are then soluble in a polar DMSO solution. The uncharged organic capping agent is preferably soluble in the non-polar solvent and may be thereby physically separated, from the semiconductor nanocrystal, using a separation funnel. In this manner, organic capping agents from the organic capped semiconductor nanocrystals are removed. CdSe and Sn₂Se₆²⁻ may be obtained from Sigma-Aldrich.

### Structure of Photocatalytic Capped Colloidal Nanocrystal

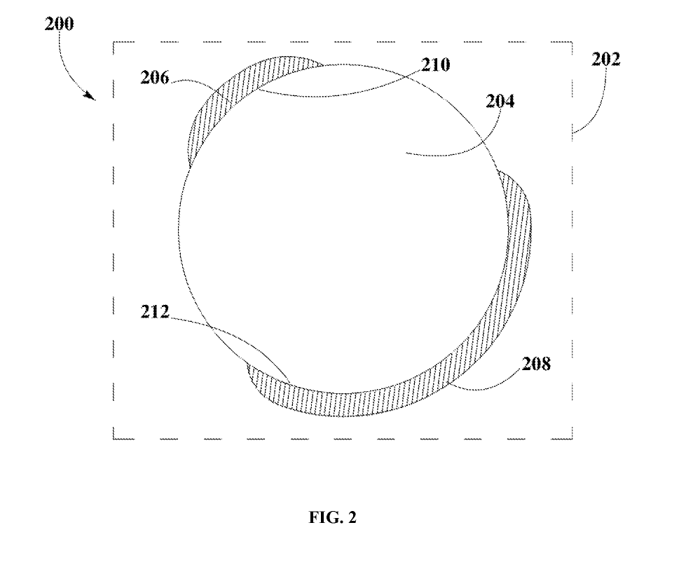

FIG. 2 depicts sphere configuration 200 of photocatalytic capped colloidal nanocrystal 202. These nanocrystals may include a single semiconductor nanocrystal 204 capped with a first inorganic capping agent 206 and a second inorganic capping agent 208. Semiconductor nanocrystals 204 shown in this embodiment may include face A 210 and face B 212; the bond strength of the second organic capping agent to face A 210 may be twice that of the bond strength of the bond of the first organic capping agent to face B 212. Organic capping agents on face B 212 may be preferably exchanged when employing the method 100 for forming photocatalytic capped colloidal nanocrystals 202 described above. Isolation and reaction of this intermediate species, having organic and inorganic capping agents, with a second inorganic capping agent 208 may produce a photocatalytic capped colloidal nanocrystal 202 with a first inorganic capping agent 206 on face B 212 and a second inorganic capping agent 208 on face A 210. Alternatively, the preferential binding of inorganic capping agents to specific single semiconductor nanocrystal 204 faces may yield the same result from a single mixture of multiple inorganic capping agents.

In another embodiment, single semiconductor nanocrystal 204 may be PbS quantum dots, with SnTe₄⁴⁻ used as first inorganic capping agent 206 and AsS₃³⁻ used as second inorganic capping agent 208, therefore forming a photocatalytic capped colloidal nanocrystal 202 represented as PbS.(SnTe₄;AsS₃).

Another aspect of the disclosed method is the possibility of a chemical reactivity between first inorganic capping agent 206 and second inorganic capping agent 208. For example, first inorganic capping agent 206 bound to the surface of semiconductor nanocrystal 204 may react with second inorganic capping agent 208. As such, method 100 may also provide for the synthesis of photocatalytic capped colloidal nanocrystals 202 that could not be selectively made from a solution of semiconductor nanocrystals 204 and inorganic capping agents. The interaction of the first inorganic capping agent 206 with semiconductor nanocrystals 204 may control both the direction and scope of the reactivity of first inorganic capping agent 206 with second inorganic capping agent 208. Furthermore, method 100 may control the specific areas where first inorganic capping agent 206 may bind to the semiconductor nanocrystal 204. The result of the addition of a combined inorganic capping agent capping semiconductor nanocrystal 204 by other methods may produce a random arrangement of the combined inorganic capping agent on semiconductor nanocrystal 204.

According to an aspect of the present disclosure, semiconductor nanocrystal 204 in photoactive material may be capped with first inorganic capping agent 206 and second inorganic capping agent 208 as a reduction photocatalyst and an oxidative photocatalyst, respectively.

In addition, the shape of semiconductor nanocrystals 204 may improve photocatalytic activity of semiconductor nanocrystals 204. Changes in shape may expose different facets as reaction sites and may change the number and geometry of step edges where reactions may preferentially take place.

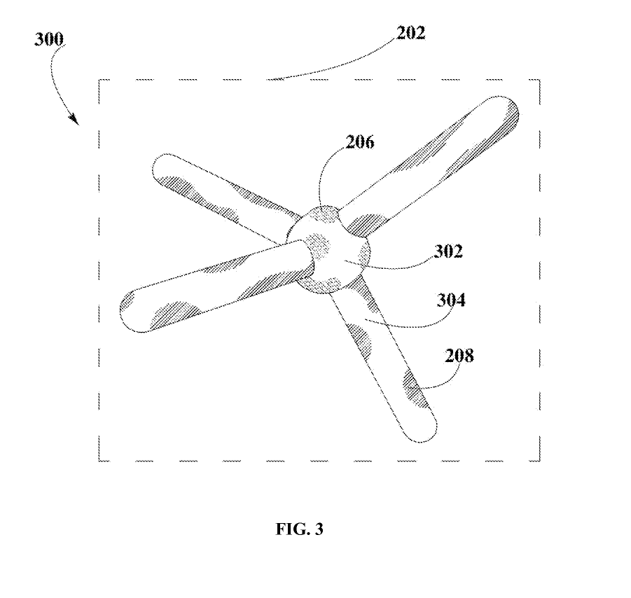

FIG. 3 depicts an embodiment of tetrapod configuration 300 of photocatalytic capped colloidal nanocrystal 202, that may include first semiconductor nanocrystal 302 that may be capped with first inorganic capping agent 206, and second semiconductor nanocrystal 304 that may be capped with second inorganic capping agent 208. As an example, photocatalytic capped colloidal nanocrystals 202 in tetrapod configuration 300 may include (CdSe;CdS).(Sn₂S₆⁴⁻;In₂Se₄²⁻), in which first semiconductor nanocrystal 302 may be (CdSe), coated with Sn₂S₆⁴⁻ as first inorganic capping agent 206, while second semiconductor nanocrystal 304 may be (CdS), capped with In₂Se₄²⁻ as second inorganic capping agent 208.

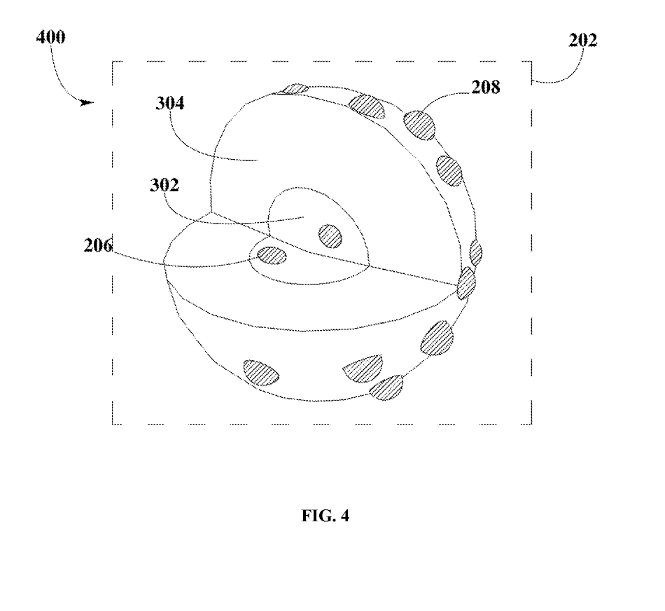

FIG. 4 depicts an embodiment of a core/shell configuration 400 of photocatalytic capped colloidal nanocrystals 202 that may include first semiconductor nanocrystal 302 and second semiconductor nanocrystal 304 that may be capped respectively with first inorganic capping agent 206 and second inorganic capping agent 208. As an example, photocatalytic capped colloidal nanocrystal 202 in core/shell configuration 400 may include (CdSe/CdS).Sn₂S₆⁴⁻, where first semiconductor nanocrystal 302 may be CdSe, while second semiconductor nanocrystal 304, may be CdS; Sn₂Se₆⁴⁻ may be both first inorganic capping agent 206 and second inorganic capping agent 208.

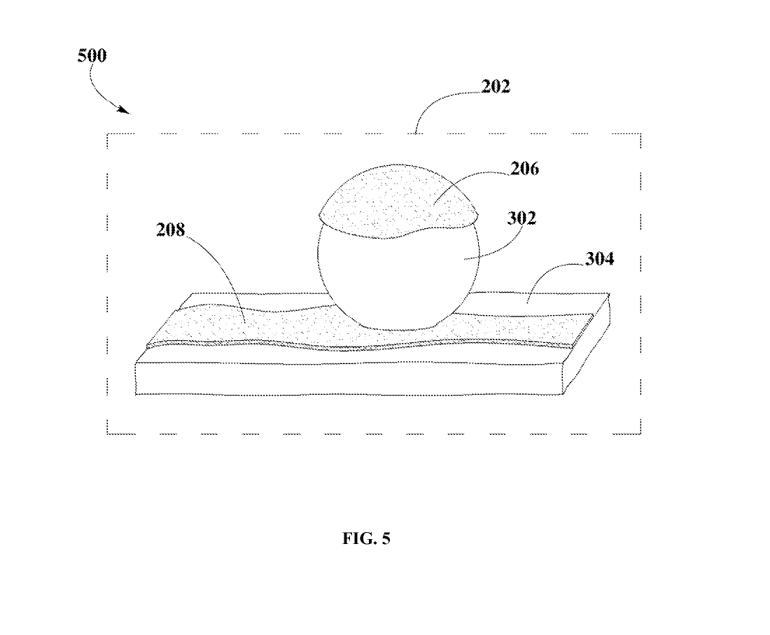

FIG. 5 shows another embodiment of a graphene configuration 500 of photocatalytic capped colloidal nanocrystal 202 including graphene oxide (GO). First semiconductor nanocrystal 302 is capped with first inorganic capping agent 206, and second semiconductor nanocrystal 304 is capped with second inorganic capping agent 208. In the present embodiment, graphene oxide may be used as second semiconductor nanocrystal 304.

Extensive interest in graphene may be associated with a unique hexagonal atomic layer structure and unusual properties, including the highest intrinsic charge carrier mobility at room temperature of all known materials, high thermal, chemical, and mechanical stability as well as high elasticity, electromechanical modulation and high surface area. These properties also represent desirable characteristics for a variety of applications in heterogeneous catalysis, sensors, hydrogen storage at molecular level, and energy conversion.

### Method of Deposition

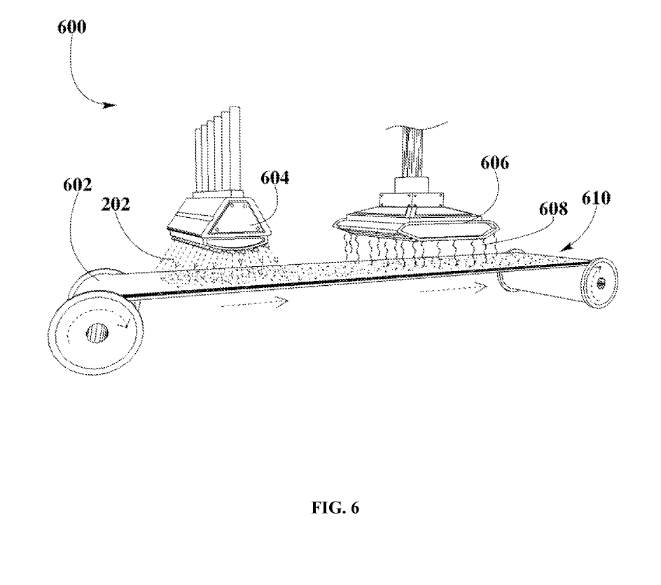

FIG. 6 depicts an embodiment of known in the art spraying deposition and annealing methods 600 used to apply and thermally treat photocatalytic capped colloidal nanocrystals 202 composition on a substrate 602. Photocatalytic capped colloidal nanocrystal 202 disclosed here may be applied on suitable substrate 602, such as Polydiallyldimethylammonium chloride (PDDA), employing a spraying device 604 during a period of time depending on desired thickness of photocatalytic capped colloidal nanocrystal 202 composition applied on substrate 602.

Yet another aspect of the current disclosure is the thermal treatment of the described photocatalytic capped colloidal nanocrystals 202. Many of first inorganic capping agents 206 or second inorganic capping agents 208 may be precursors to inorganic materials (matrices) and low-temperature thermal treatment of the first inorganic capping agents 206 or second inorganic capping agents 208 employing a convection heater 606 may provide a gentle method to produce crystalline films from photocatalytic capped colloidal nanocrystals 202. The thermal treatment of photocatalytic capped colloidal nanocrystals 202 may yield, for example, ordered arrays of semiconductor nanocrystals 204 within an inorganic matrix, hetero-alloys, or alloys. In at least one embodiment here, convection heat 608 applied over photocatalytic capped colloidal nanocrystals 202 may reach temperatures less than about 350, 300, 250, 200, and/or 180° C.

As a result of spraying deposition and annealing methods 600, photoactive material 610 may be formed. Photoactive material 610 may then be cut into films to be used in subsequent water splitting methods.

In addition to spraying deposition and annealing methods 600, other deposition methods of photocatalytic capped colloidal nanocrystals 202 may include sputter deposition, electrostatic deposition, spin coating, inkjet deposition, laser printing (matrices), among others.

According to another embodiment, deposition on a substrate 602 may not be needed. Accordingly, photocatalytic capped colloidal nanocrystals 202 may be deposited into a crucible to be then annealed. The solid photocatalytic capped colloidal nanocrystals 202 may then be ground into particles and sintered to form photoactive material 610 that may be deposited on a surface where it may adhere. In another embodiment, ground particles may be used directly as photoactive material 610.

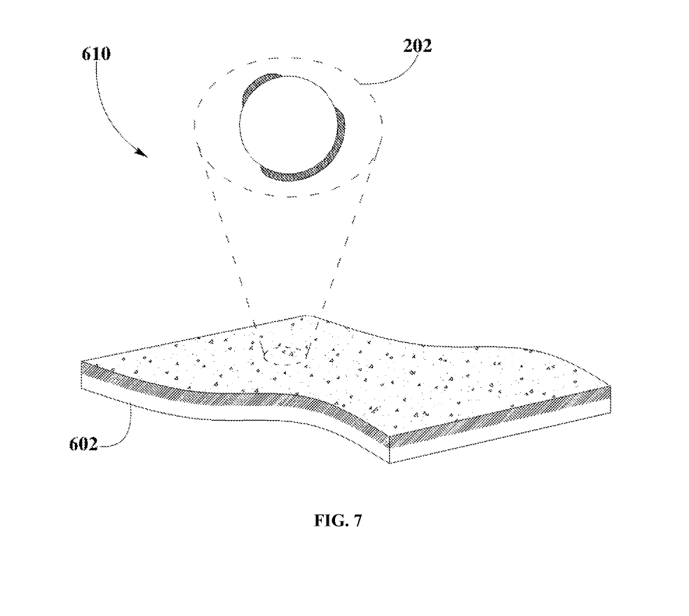

FIG. 7 illustrates photoactive material 610 including treated photocatalytic capped colloidal nanocrystals 202 in sphere configuration 200 over substrate 602. Photocatalytic capped colloidal nanocrystals 202 in photoactive material 610 may also exhibit tetrapod configuration 300, core/shell configuration 400, and graphene configuration 500, among others.

In order to measure the performance of photoactive material 610, devices such as transmission electron microscopy (TEM) and energy dispersive X-ray (EDX), among others, may be utilized. Performance of photoactive material 610 may be related to light absorbance, charge carriers mobility and energy conversion efficiency.

### System Configuration and Function

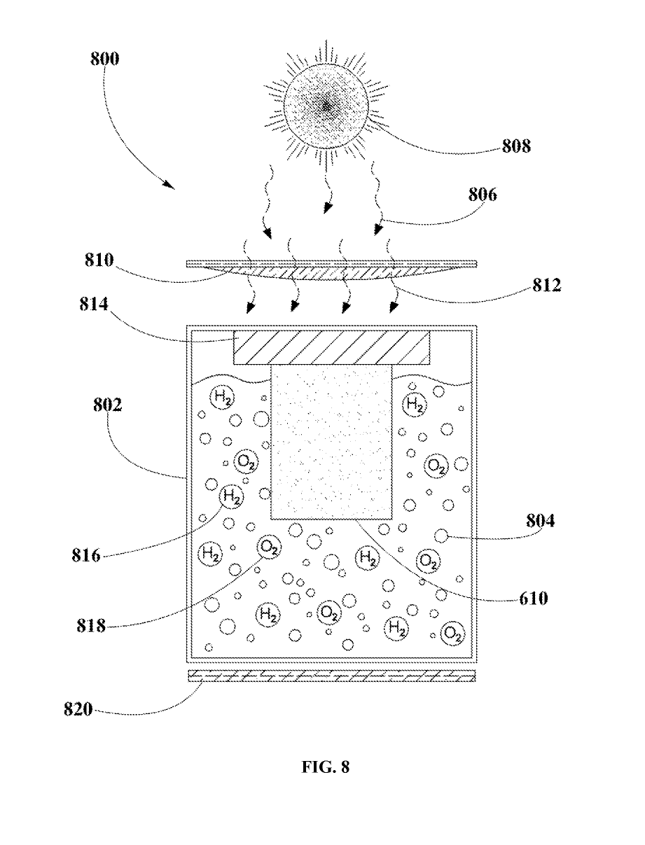

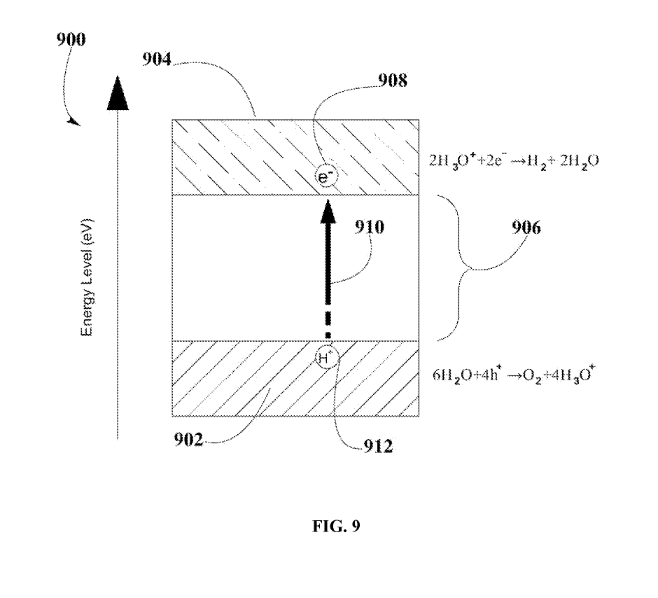

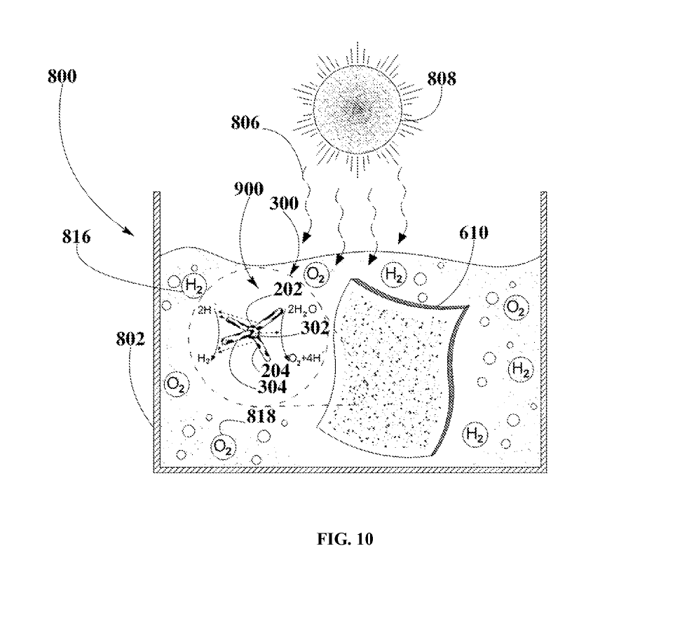

FIG. 8 depicts water splitting process 800, where reaction vessel 802 includes photoactive material 610 submerged in water 804. Light 806 coming from light source 808 may be intensified by a light intensifier 810, which can be a solar concentrator, such as a parabolic solar concentrator. Light intensifier 810 may reflect light 806 and may direct intensified light 812 at reaction vessel 802 through window 814. Subsequently, intensified light 812 may make contact with photoactive material 610 (explained in FIG. 6), to produce charge separation (explained in FIG. 9) and charge transfer (explained in FIG. 10) in the boundary between photoactive material 610 and water 804, splitting water 804 into hydrogen gas 816 and oxygen gas 818. Alternatively, a solar reflector 820 may be positioned at the bottom or any side of reaction vessel 802 to reflect intensified light 812 back to reaction vessel 802 and re-utilize the intensified light 812.

According to various embodiments, one or more walls of reaction vessel 802 may be formed of glass or other transparent material, so that intensified light 812 may enter reaction vessel 802. It is also possible that most or all of the walls of reaction vessel 802 are transparent such that intensified light 812 may enter from many directions. In another embodiment, reaction vessel 802 may have one side which is transparent to allow the incident radiation to enter and the other sides may have a reflective interior surface which reflects the majority of the solar radiation.

Any suitable light source 808 may be employed to provide light 806 for generating water splitting process 800 to produce hydrogen gas 816 and oxygen gas 818. A preferable light source 808 is sunlight, including infrared light 806 which may be used to heat water 804 and also ultraviolet light 806 and visible light 806 which may be used in water splitting process 800. The ultraviolet light 806 and visible light 806 may also heat water 804, directly or indirectly. Sunlight may be diffuse light 806, direct light 806, or both. Light 806 may be filtered or unfiltered, modulated or unmodulated, attenuated or unattenuated. Preferably, light 806 may be concentrated to increase the intensity using light intensifier 810, which may include a suitable combination of lenses, mirrors, waveguides, or other optical devices, to increase the intensity of light 806. The increase in the intensity of light 806 may be characterized by the intensity of light 806 having from about 300 to about 1500 nm (e.g., from about 300 nm to about 800 nm) in wavelength. Light intensifier 810 may increase the intensity of light 806 by any factor, preferably by a factor greater than about 2, more preferably a factor greater than about 10, and most preferably a factor greater than about 25.

As a result of employing water splitting process 800, improved efficiency of converting light 806 energy into chemical energy may be achieved. Hydrogen gas 816, when reacted with oxygen gas 818 liberates 2.96 eV per water 804 molecule. Thus, the required amount of chemical energy can be determined by multiplying the number of hydrogen molecules generated by 2.96 eV. The energy of solar light 806 is defined as the amount of energy in light 806 having a wavelength from about 300 nm to about 800 nm. A typical solar intensity as measured at the Earth's surface, thus defined, is about 500 watts/m². The efficiency of water splitting process 800 can be calculated as:

Efficiency=[2.96 eV×(1.602×10−19 J/eV)−N/t]/(IL×AL) (1)

where t is the time in seconds,

I_{L} is the light intensity of (between 300 nm and 800 nm) in watts/m²,

A_{L} is the area of light entering reaction vessel in m²,

N is the number of hydrogen molecules generated in time t, and

1 watt=1 J/s.

FIG. 9 shows the charge separation process 900 that may occur during water splitting process 800. Semiconductor nanocrystals within photoactive material 610 may be used to produce charge carriers for use in redox reactions for water splitting process 800. The energy difference between valence band 902 and conduction band 904 of a semiconductor nanocrystal 204 is known as the band gap 906. The valence band 902 refers to the outermost electron 908 shell of atoms in semiconductor nanocrystals 204 in which electrons 908 are too tightly bound to the atom to carry electric current, while conduction band 904 refers to the band of orbitals that are high in energy and are generally empty. Band gap 906 of semiconductor nanocrystals 204 should be large enough to drive water splitting process 800 reactions but small enough to absorb a large fraction of light 806 wavelengths. Accordingly, only photons with energy larger than or equal to band gap 906 are absorbed.

A process triggered by photo-excitation 910 may be triggered when light 806 with energy equal to or greater than that of band gap 906 makes contact with semiconductor nanocrystals 204 in photoactive material 610, and therefore electrons 908 are excited from valence band 902 to conduction band 904, leaving holes 912 behind in valence band 902. Changing the materials and shapes of semiconductor nanocrystals 204 may enable the tuning of band gap 906 and band-offsets to expand the range of wavelengths usable by semiconductor nanocrystal 204 and to tune the band positions for redox processes.

For water splitting process 800, the photo-excited electron 908 in semiconductor nanocrystal 204 should have a reduction potential greater than or equal to that necessary to drive the following reaction:

2H₃O⁺+2e⁻→H₂+2H2O (2)

The stated reaction has a standard reduction potential of 0.0 eV vs. the standard hydrogen electrode (SHE), or standard hydrogen potential of 0.0 eV. A hydrogen (H₂) molecule in water 804 may be reduced when receiving two photo-excited electrons 908 moving from valence band 902 to conduction band 904. On the other hand, the photo-excited hole 912 should have an oxidation potential greater than or equal to that necessary to drive the following reaction:

6H₂O+4h⁺→O₂+4H₃O⁺ (3)

The reaction set out above may exhibit a standard oxidation potential of −1.23 eV vs. SHE. Oxygen (O₂) molecule in water 804 may be oxidized by four holes 912. Therefore, the absolute minimum band gap 906 for semiconductor nanocrystal 204 in water splitting process 800 reaction is 1.23 eV. Given over potentials and loss of energy for transferring the charges to donor and acceptor states, the minimum energy may be closer to 2.1 eV. The wavelength of the irradiation light 806 may be required to be about 1010 nm or less, in order to allow electrons 908 to be excited and jump over band gap 906.

Electrons 908 may acquire energy corresponding to the wavelength of the absorbed light 806. Upon being excited, electrons 908 may relax to the bottom of conduction band 904, which may lead to recombination with holes 912 and therefore to an inefficient water splitting process 800. For an efficient charge separation process 900, a reaction should take place to quickly sequester and hold electron 908 and hole 912 for use in subsequent redox reactions used for water splitting process 800.

Following photo-excitation 910 to conduction band 904, electron 908 can quickly move to the acceptor state of first inorganic capping agent 206 and hole 912 can move to the donor state of second inorganic capping agent 208, preventing recombination of electrons 908 and holes 912. First inorganic capping agent 206 acceptor state and second inorganic capping agent 208 donor state lie energetically between the band edge states and the redox potentials of the hydrogen and oxygen producing half-reactions. The sequestration of the charges into these states may also physically separate electrons 908 and holes 912, in addition to the physical charge carrier separation that occurs in the boundaries between individual semiconductor nanocrystals 204. Being more stable to recombination in the donor and acceptor states, charge carriers may be efficiently stored for use in redox reactions required for photocatalytic water splitting process 800.

FIG. 10 depicts an embodiment of water splitting process 800 taking place in the boundary between photoactive material 610 and water 804, where photoactive material 610 may include photocatalytic capped colloidal nanocrystals 202. In FIG. 10, photocatalytic capped colloidal nanocrystals 202 may include a first semiconductor nanocrystal 302 and a second semiconductor nanocrystal 304 capped respectively with first inorganic capping agent 206 and second inorganic capping agent 208. According to an embodiment, first inorganic capping agent 206 and second inorganic capping agent 208 act as reduction photocatalyst and oxidation photocatalyst, respectively. When light 806 emitted by light source 808 makes contact with first semiconductor nanocrystal 302 and second semiconductor nanocrystal 304, charge separation process 900 and charge transfer process may take place between first semiconductor nanocrystal 302, second semiconductor nanocrystal 304, first inorganic capping agent 206 and second inorganic capping agent 208. As a result, hydrogen is reduced by electrons 908 moving from valence band 902 to conduction band 904 on first semiconductor nanocrystal 302 when electrons 908 are transferred via first inorganic capping agent 206 to water 804, producing hydrogen gas 816 molecules. On the other hand, oxygen is oxidized by holes 912 on second semiconductor nanocrystal 304 when holes 912 are transferred via second inorganic capping agent 208 to water 804, resulting in the production of oxygen gas 818 molecules.

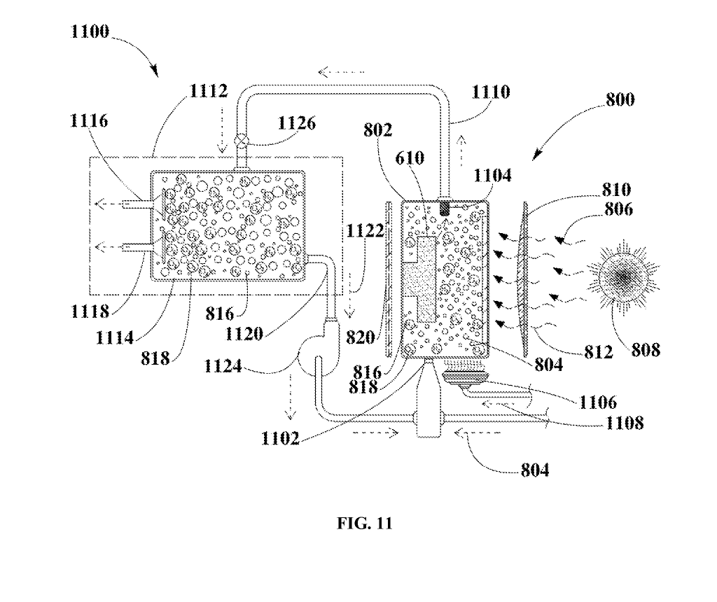

FIG. 11 shows a water splitting system 1100 employing water splitting process 800.

A continuous flow of water 804 as gas or liquid may enter reaction vessel 802 through a nozzle 1102. Subsequently, water 804 may pass through a region including photoactive material 610 and may exit through a filter 1104. Water 804 coming through nozzle 1102 may also include hydrogen gas 816, oxygen gas 818 and other gases such as an inert gas or air. According to an embodiment, water 804 entering reaction vessel 802 may include recirculated gas removed from reaction vessel 802 and residual water 804 which did not react in reaction vessel 802 along with hydrogen gas 816 and oxygen gas 818, as well as any other gas in water splitting system 1100. Preferably, a heater 1106 is connected to reaction vessel 802 to produce heat 1108, so that water 804 may boil, facilitating the extraction of hydrogen gas 816 and oxygen gas 818 through filter 1104. Heater 1106 may be powered by different energy supplying devices. Preferably, heater 1106 may be powered by renewable energy supplying devices, such as photovoltaic cells, or by energy stored employing the system and method from the present disclosure. Materials for the walls of reaction vessel 802 may be selected based on the reaction temperature.

Filter 1104 may allow the exhaust of water 804 from reaction vessel 802, including hydrogen gas 816, oxygen gas 818 and water 804 which may flow through exhaust tube 1110. In an embodiment where photocatalytic capped colloidal nanocrystals 202 are used in particulate form, filter 1104 may also help to extract water 804, hydrogen gas 816, and oxygen gas 818, while keeping photocatalytic capped colloidal nanocrystals 202 inside reaction vessel 802.

After passing through reaction vessel 802, water 804, hydrogen gas 816, and oxygen gas 818 may be transferred through exhaust tube 1110 to a collector 1112 which may include a reservoir 1114 connected to a hydrogen permeable membrane 1116 (e.g. silica membrane) and an oxygen permeable membrane 1118 (e.g. silanized alumina membrane) for collecting hydrogen gas 816 and oxygen gas 818 to be stored in tanks or any other suitable storage equipment. Collector 1112 may also be connected to a recirculation tube 1120 which may transport remaining exhaust gas 1122 back to nozzle 1102 to supply additional water 804 to reaction vessel 802. Additionally, remaining exhaust gas 1122 may be used to heat water 804 entering nozzle 1102. The flow of hydrogen gas 816, oxygen gas 818 and water 804 in water splitting system 1100 may be controlled by one or more pumps 1124, valves 1126, or other flow regulators.

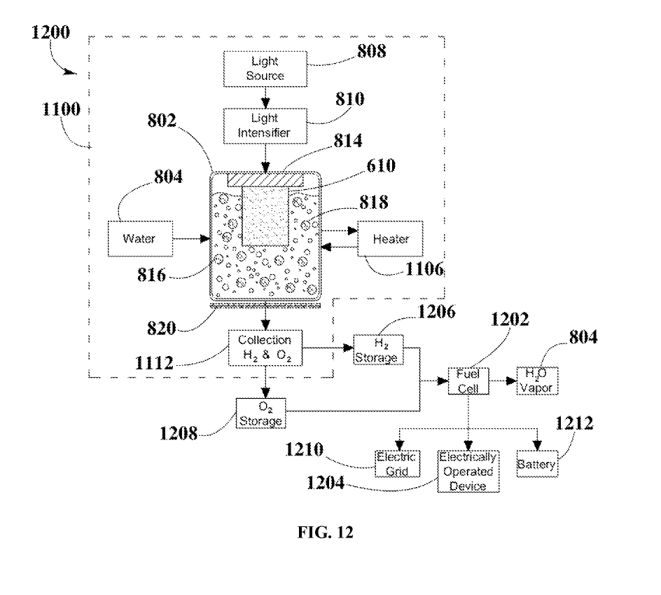

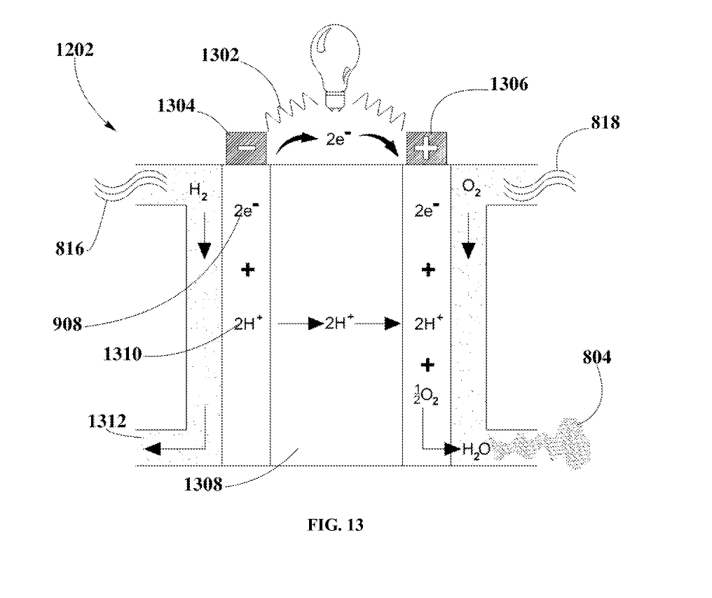

FIG. 12 depicts energy generation system 1200 that may be used to generate and store hydrogen gas 816 and oxygen gas 818 for use in a hydrogen fuel cell 1202 (explained in detail in FIG. 13), generating electricity that may be employed in one or more electrically driven applications 1204, according to an embodiment.

Hydrogen gas 816 and oxygen gas 818 resulting from water splitting system 1100 may be stored in hydrogen storage 1206 and oxygen storage 1208. Hydrogen gas 816 and oxygen gas 818 may then be combined in a hydrogen fuel cell 1202 that may produce water 804 vapor or liquid and electricity, the latter of which may be provided to an electric grid 1210, used in an electrically driven application 1204 (e.g. a motor, light, heater, pump, amongst others), stored in a battery 1212, or any combination thereof.

According to another embodiment, electricity may be produced by burning hydrogen gas 816 to produce steam and then generating electricity using a steam Rankine cycle—generator set.

Energy generation system 1200 may be mounted on a structure such as the roof of a building, or may be free standing, such as in a field. Energy generation system 1200 may be stationary, or may be on a mobile structure (e.g. a transportation vehicle, such as a boat, an automotive vehicle, and farming machinery). The mounting of energy generation system 1200 may include elements for adjusting the positioning of reaction vessel 802, light intensifier 810 or both, such that the intensity of intensified light 812 in reaction vessel 802 may be increased. For example, light intensifier 810 may be adjusted to track the position sunlight. Such adjustments to the position of light intensifier 810 may be made to accommodate seasonal or daily positioning of the sun. Preferably the adjustments are made frequently throughout the day.

FIG. 13 depicts a hydrogen fuel cell 1202 that may be used for mixing hydrogen gas 816 and oxygen gas 818 for the production of electricity 1302 and water 804. Hydrogen fuel cell 1202 may include two electrodes, an anode 1304 making contact with hydrogen gas 816 and a cathode 1306 making contact with oxygen gas 818, separated by an electrolyte 1308 that allows charges to move between both sides of hydrogen fuel cell 1202. Electrolyte 1308 is electrically insulating, specifically designed so protons 1310 (H⁺) can pass through, but electrons 908 (e−) cannot.

At anode 1304, a catalyst oxidizes incoming hydrogen gas 816, forming hydrogen protons 1310 and electrons 908. Hydrogen gas 816 that has not reacted with the catalyst in anode 1304 may leave hydrogen fuel cell 1202 via hydrogen exhaust 1312. Freed electrons 908 may travel through a conductor such as a wire (not shown) creating electricity 1302 that may be used to power electrically driven applications 1204, while protons 1310 may travel through electrolyte 1308 to cathode 1306. Once reaching cathode 1306, hydrogen protons 1310 may reunite with electrons 908, subsequently reacting and combining with oxygen gas 818, to produce water 804.

While various aspects and embodiments have been disclosed here, other aspects and embodiments are contemplated. The various aspects and embodiments disclosed here are for purposes of illustration and are not intended to be limiting, with the true scope and spirit being indicated by the following claims.

I claim:

1. A method for producing photocatalytic capped colloidal nanocrystals, comprising
reacting a semiconductor nanocrystals precursor and an organic solvent to produce organic capped semiconductor nanocrystals;
substituting an inorganic capping agent for the organic capping agent, including
dissolving the inorganic capping agent in a first solvent to produce a first solution;
dissolving the organic capped nanocrystals in a second solvent to produce a second solution;
combining the first solution and the second solution in a single vessel;
reacting the first solution with the second solution, whereby a portion of the organic capping agent is displaced by inorganic capping agent;
continuing reacting until the combination reaches equilibrium;
allowing the combination to stabilize; and
precipitating photocatalytic capped colloidal nanocrystals from the combination.

2. The method of claim 1, wherein the organic solvent is a stabilizing organic ligand.

3. The method of claim 1, wherein the organic solvent is trioctylphosphine oxide.

4. The method of claim 1, wherein the organic solvent is one of a long-chain aliphatic amines, long-chain aliphatic phosphines, long-chain aliphatic carboxylic acids, long-chain aliphatic phosphonic acids and mixtures thereof.

5. The method of claim 1, wherein the organic capped semiconductor nanocrystals are formed as one of nanocrystals, nanorods, nanoplates, nanowires, dumbbell-like nanoparticles, or dendritic nano materials.

6. The method of claim 1, wherein the first solvent is polar.

7. The method of claim 1, wherein the second solvent is immiscible with the first solvent and is generally nonpolar.

8. The method of claim 1, wherein substituting occurs in a nitrogen environment inside a glove box.

9. The method of claim 1, wherein the inorganic capping agent is one of polyoxometalate or oxometalate, including one of tungsten oxide, iron oxide, gallium zinc nitride oxide, bismuth vanadium oxide, zinc oxide, or titanium dioxide.

10. The method of claim 1, wherein the inorganic capping agent is one of a transition metal, lanthanide, actinide, main group metal, metalloid, soluble metal chalcogenide or metal carbonyl chalcogenide.

11. The method of claim 1, wherein the inorganic capping agent is a Zintl ion.

12. The method of claim 1, wherein the semiconductor nanocrystal is CdSe, the organic solvent is hexane, the first solvent is DMSO, and the inorganic capping agent is Sn₂Se₆²⁻.

13. The method of claim 1, further comprising reacting the first solution with a second inorganic capping agent, whereby a portion of the organic capping agent is displaced by the second inorganic capping agent.

14. The method of claim 1 wherein the photocatalytic capped colloidal nanocrystal is a PbS quantum dot, SnTe₄⁴⁻ is the first inorganic capping agent, and AsS₃³⁻ is the second inorganic capping agent, and the photocatalytic capped colloidal nanocrystal is represented as PbS.(SnTe₄;AsS₃).

15. A photocatalytic capped colloidal nanocrystal, comprising
a first semiconductor nanocrystal;
a first inorganic capping agent overlying at least a first face of the nanocrystal;
a second inorganic capping agent overlying at least a second face of the nanocrystal.

16. The nanocrystal of claim 15, wherein the first semiconductor nanocrystal is a PbS quantum dot, the first inorganic capping agent is SnTe₄⁴⁻, and AsS₃³⁻ is the second inorganic capping agent.

17. The nanocrystal of claim 15, further comprising a second semiconductor nanocrystal abutting and joined to the first nanocrystal, and wherein the first inorganic capping agent overlies the single semiconductor nanocrystal and the second inorganic capping agent overlies the second semiconductor nanocrystal.

18. The nanocrystal of claim 17, wherein the second nanocrystal forms a tetrapod, the arms of the tetrapod extending from the first nanocrystal.

19. The nanocrystal of claim 17, wherein the first nanocrystal and the second nanocrystal are generally spherical in form, with the second nanocrystal encapsulating the single nanocrystal and the first inorganic capping agent be at least partially embedded in the single nanocrystal.

20. The nanocrystal of claim 17, wherein the second nanocrystal is graphene oxide.

21. A method for splitting water molecules, comprising
submerging a photoactive material in water contained in a reaction vessel; and
inducing reduction-oxidation reactions in the water, including
illuminating the photoactive material with the incident light, the incident light including photons having an energy level greater than the band gap of the photoactive material;
exciting electrons in the photoactive material from the valence band into the conduction band, as a result of the illuminating;
forming holes in the photoactive material as a result of the exciting;
reducing water molecules to form hydrogen gas as a result of the exciting electrons; and
oxidizing water molecules to form oxygen gas as a result of the forming.

22. The method of claim 21, wherein the photoactive material is the nanocrystal of claim 1.

23. The method of claim 21, further comprising collecting the hydrogen gas and the oxygen gas.

24. The method of claim 1, wherein the semiconductor nanocrystal is selected from the group comprising AlN, AlP, AlAs, Ag, Au, Bi, Bi₂S₃, Bi₂Se₃, Bi₂Te₃, CdS, CdSe, CdTe, Co, CoPt, CoPt₃, Cu, Cu₂S, Cu₂Se, CuInSe₂, CuIn₍₁₋ₓ₎Gaₓ(S,Se)₂, Cu₂ZnSn(S,Se)₄, Fe, FeO, Fe₂O₃, Fe₃O₄, FePt, GaN, GaP, GaAs, GaSb, GaSe, Ge, HgS, HgSe, HgTe, InN, InP, InSb, InAs, Ni, PbS, PbSe, PbTe, Pd, Pt, Ru, Rh, Si, Sn, ZnS, ZnSe, ZnTe, Au/PbS, Au/PbSe, Au/PbTe, Ag/PbS, Ag/PbSe, Ag/PbTe, Pt/PbS, Pt/PbSe, Pt/PbTe, Au/CdS, Au/CdSe, Au/CdTe, Ag/CdS, Ag/CdSe, Ag/CdTe, Pt/CdS, Pt/CdSe, Pt/CdTe, Au/FeO, Au/Fe₂O₃, Au/Fe₃O₄, Pt/FeO, Pt/Fe₂O₃, Pt/Fe₃O₄, FePt/PbS, FePt/PbSe, FePt/PbTe, FePt/CdS, FePt/CdSe, FePt/CdTe, CdSe/CdS, CdSe/ZnS, InP/CdSe, InP/ZnS, InP/ZnSe, InAs/CdSe, InAs/ZnSe; CdSe nanorods; CdSe/CdS core/shell nanorods; CdTe nano-tetrapods; and CdSe/CdS core/shell nano-tetrapods.

25. The method of claim 1, wherein the first solvent is selected from the group comprising 1,3-butanediol, acetonitrile, ammonia, benzonitrile, butanol, dimethylacetamide, dimethylamine, dimethylethylenediamine, dimethylformamide, dimethylsulfoxide (DMSO), dioxane, ethanol, ethanolamine, ethylenediamine, ethyleneglycol, formamide (FA), glycerol, methanol, methoxyethanol, methylamine, methylformamide, methylpyrrolidinone, pyridine, tetramethylethylenediamine, triethylamine, trimethylamine, trimethylethylenediamine, water, and mixtures thereof.

26. The method of claim 1, wherein the second solvent is selected from the group comprising pentane, pentanes, cyclopentane, hexane, hexanes, cyclohexane, heptane, octane, isooctane, nonane, decane, dodecane, hexadecane, benzene, 2,2,4-trimethylpentane, toluene, petroleum ether, ethyl acetate, diisopropyl ether, diethyl ether, carbon tetrachloride, carbon disulfide, and mixtures thereof.

27. The method of claim 11, wherein the Zintl ion is selected from the group comprising As₃³⁻, As₄²⁻, As₅³⁻, As₇³⁻, Ae₁₁³⁻, AsS₃³⁻, As₂Se₆³⁻, As₂Te₆³⁻, As₁₀Te₃²⁻, Au₂Te₄²⁻, Au₃Te₄³⁻, Bi₃³⁻, Bi₄²⁻, Bi₅³⁻, GaTe²⁻, Ge₉²⁻, Ge₉⁴⁻, Ge₂S₆⁴⁻, HgSe₂²⁻, Hg₃Se₄²⁻, In₂Se₄²⁻, In₂Te₄²⁻, Ni₅Sb₁₇⁴⁻, Pb₅²⁻, Pb₇⁴⁻, Pb₉⁴⁻, Pb₂Sb₂²⁻, Sb₃³⁻, Sb₄²⁻, Sb₇³⁻, SbSe₄³⁻, SbSe₄⁵⁻, SbTe₄⁵⁻, Sb₂Se₃⁻, Sb₂Te₅⁴⁻, Sb₂Te₇⁴⁻, Sb₄Te₄⁴⁻, Sb₉Te₆³⁻, Se₂²⁻, Se₃²⁻, Se₄²⁻, Se_{5,6}²⁻, Se₆²⁻, Sn₅²⁻, Sn₉³⁻, Sn₉⁴⁻, SnS₄⁴⁻, SnSe₄⁴⁻, SnTe₄⁴⁻, SnS₄Mn₂⁵⁻, SnS₂S₆⁴⁻, Sn₂Se₆⁴⁻, Sn₂Te₆⁴⁻, Sn₂Bi₂²⁻, Sn₈Sb³⁻, Te₂²⁻, Te₃²⁻, Te₄²⁻, Tl₂Te₂²⁻, TlSn₈³⁻, TlSn₈⁵⁻, TlSn₉³⁻, TlTe₂²⁻, and mixed metal SnS₄Mn₂⁵⁻.

28. The method of claim 1, wherein the inorganic capping agent is selected from the group comprising CuInSe₂, CuInₓGa₁₋ₓSe₂, Ga₂Se₃, In₂Se₃, In₂Te₃, Sb₂S₃, Sb₂Se₃, Sb₂Te₃, ZnTe, vanadium tetrasulfide, niobium tetrasulfide, tantalum tetrasulfide, molybdenum tetrasulfide, tungsten tetrasulfide, and rhenium tetrasulfide, vanadium tetraselenide, niobium tetraselenide, tantalum tetr tetraselenide, molybdenum tetraselenide, tungsten tetraselenide, and rhenium tetraselenide, and the tetratelluride of niobium tetratelluride, tantalum tetratelluride, and tungsten tetratelluride.

29. The method of claim 1, wherein the photocatalytic capped colloidal nanocrystal is selected from the group comprising Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄FePt/PbSe.SnS₄, FePt/PbTe.SnS₄, FePt/CdS.SnS₄, FePt/CdSe.SnS₄, FePt/CdTe.SnS₄, Au/PbS.In₂Se₄Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄ FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄,CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄.
